(19) United States
(12) Patent Application Publication
(10) Pub. No.: US 2008/0288518 A1
(43) Pub. Date: Nov. 20, 2008

(54) CONTENT DATA BLOCK PROCESSING

(75) Inventors: MICHIHITO MATSUO, TOKYO (JP); ASAO HIRANO, KANAGAWA (JP); YOKO INOUE, Matsudo-shi (JP)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/748,644

(22) Filed: May 15, 2007

(51) Int. Cl. G06F 7/10

(52) U.S. Cl. 707/101; 707/104.1

(57) ABSTRACT

The present invention provides a method for processing content data. The method comprises buffering a sequence of received compressed content data blocks (510), determining a level of available buffering for the received compressed content data blocks (550), determining a sub-set of compressed content data blocks to be decoded from the sequence of received compressed content data blocks (515), the sub-set of compressed content data blocks being dependent on the level of available buffering, and decoding the sub-set of compressed content data blocks to generate decompressed content data blocks (520).

### FIELD OF THE INVENTION

The present invention relates generally to the field of receiving and playing content streams such as video content, especially though not exclusively on limited processing capacity portable electronic devices such as mobile phones.

### BACKGROUND OF THE INVENTION

Portable electronic devices such as mobile phones are increasingly being used to receive and play multimedia or content streams, typically received over a wireless air interface. The content or multimedia streams comprise sequential frames or content data blocks of video and/or audio data which are received and processed by the electronic device in order to display images and or generate sounds. Video streams such as those used by digital broadcast TV systems such as DVB-H (Digital Video Broadcasting-Handheld, ETSI standard EN 302 304), DMB (Digital Media Broadcasting) and ISDB-T (Integrated Services Digital Broadcasting-Terrestrial) require a large bandwidth and high processing power or capacity which can be difficult to implement successfully on limited processing power devices. The content data blocks are compressed according to a compression format such as MPEG-4. More recently the H.264 variant of the MPEG-4 format has been gaining increasing popularity, and uses compressed slices, a combination of these slices making up each picture.

In order to play received video data blocks such as MPEG-4 pictures, the content data blocks must first be decoded or decompressed which is a processor intensive activity. In limited processing capacity electronic devices such as mobile phones, the ability to decode the received content data blocks may be reduced by the need for processing capacity for other functions which the electronic device must perform. Examples include taking a phone call, performing a user application such as accessing calendar entries, or performing scheduled operations such as backup. When the electronic device is unable to provide sufficient processing capacity in order to keep up with the decoding demands of a video stream, some of the video data blocks or pictures are dropped or skipped so that they are not decoded. Whilst this results in a loss of quality of the displayed images, dropping of some of the video data blocks allows the electronic device to play the pictures in substantially real time in order to maintain a smooth playback.

The decision to drop some frames, pictures or content (e.g. video) data blocks is typically based on the time delay or lag determined from decoded content data blocks. Thus if the time delay exceeds a certain threshold, some of the content data blocks such as predictive frames in MPEG-4 are dropped so that only a sub-set of the received content data blocks are decoded. This allows the content data blocks which are decoded to be shown without significant delay (smooth playback) which improves the user's experience of the video stream.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry of an electronic device in accordance with an embodiment of the invention;

FIG. 2 is a schematic diagram illustrating content data blocks;

FIG. 3 is a schematic block diagram illustrating functional components implemented on the electronic device of FIG. 1 in accordance with an embodiment of the invention;

FIG. 4A is a schematic diagram illustrating the skipping of content data blocks in accordance with an embodiment of the invention;

FIG. 4B is a schematic diagram illustrating the skipping of compressed H.264 slices in accordance with an embodiment of the invention;

FIG. 5 is a flow diagram illustrating a set of three overlapping methods for skipping content data blocks in accordance with an embodiment of the invention;

FIG. 6 is a flow diagram illustrating a method of determining a process level for the method of FIG. 5 in accordance with an embodiment of the invention; and

FIG. 7 is a graph illustrating the expected delay in processing decompressed video data blocks in order to display the corresponding video pictures when using the method of FIG. 5 and a known method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and device components related to processing received content data blocks. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device. An element proceeded by “comprises . . . a” does not, without more constraints, preclude the existence of additional identical elements in the process, method, article, or device that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of processing received content data blocks described herein. The non-processor circuits may include, but are not limited to, a radio receiver, a radio transmitter, signal drivers, clock circuits, power source circuits, and user input devices. As such, these functions may be interpreted as steps of a method for processing received content data blocks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

According to one aspect of the present invention there is provided a method for processing content data, comprising: buffering a sequence of received compressed content data blocks; determining a level of available buffering for the received compressed content data blocks; determining a sub-set of compressed content data blocks to be decoded from the sequence of received compressed content data blocks, the sub-set of compressed content data blocks being dependent on the level of available buffering; and decoding the sub-set of compressed content data blocks to generate decompressed content data blocks.

According to another aspect of the present invention there is provided an electronic device comprising: a buffer arranged to buffer a sequence of received compressed content data blocks; a decoder coupled to the buffer and arranged to generate decompressed content data blocks in response to receiving compressed content data blocks; a processor arranged to determine a level of available buffering for the compressed content data blocks from the buffer and to determine a sub-set of compressed content data blocks to be forwarded to the decoder from the buffer, the sub-set of compressed content data blocks being dependent on the level of available buffering.

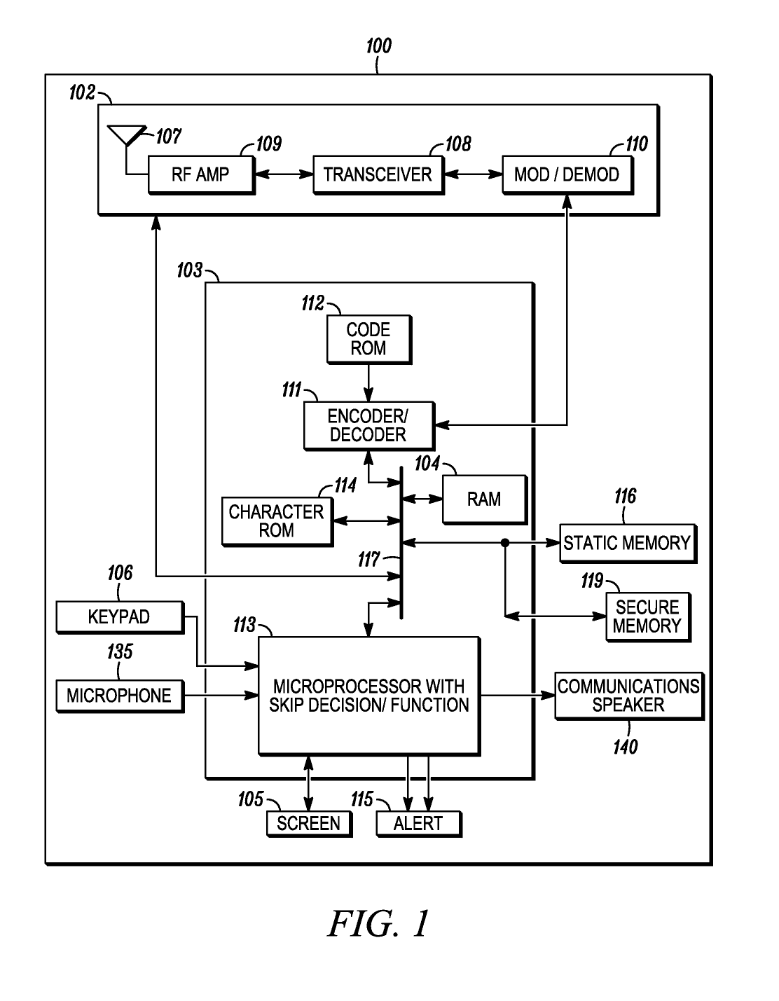

Referring to FIG. 1, there is a schematic diagram illustrating an electronic device 100, typically a wireless communications device, in the form of a mobile station or mobile phone comprising a radio frequency communications unit 102 coupled to be in communication with a processor 103. The electronic device 100 also has a display screen 105 which may include a touch sensitive screen for receiving user data entry or function operation instructions from a user of the device. There is also an alert module 115 that typically contains an alert speaker, vibrator motor and associated drivers. The display screen 105, and alert module 115 are coupled to be in communication with the processor 103. The electronic device also has a keypad 106 containing a number of keys which may be actuated by a user of the device in order to enter user data or operate certain functions of the device.

The processor 103 is operatively coupled to various memory components and includes an encoder/decoder 111 with an associated code Read Only Memory (ROM) 112 for storing data for encoding and decoding voice or other signals that may be transmitted or received by the electronic device 100. The processor 103 also includes a micro-processor with skip decision/function 113 coupled, by a common data and address bus 117, to the radio frequency communications unit 102, the encoder/decoder 111, a character Read Only Memory (ROM) 114, a Random Access Memory (RAM) 104, static programmable memory 116 and a Secure Memory 119 which may comprise a subscriber identity card (SIM or RUIM) in subscriber card based mobile phones. The static programmable memory 116 and a secure memory 119 store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The secure memory 119 and static memory 116 may also store passwords for allowing accessibility to password-protected functions on the mobile telephone 100.

The micro-processor with skip decision/function 113 has ports for coupling to the display screen 105, the alert module 115 and the keypad 106. Also, micro-processor with skip decision/function 113 has ports for coupling to a microphone 135 and a communications speaker 140 that are integral with the device.

The character Read Only Memory 114 stores code for decoding or encoding text messages that may be received by the communications unit 102. In this embodiment the character Read Only Memory 114, RUIM card 119, and static memory 116 may also store Operating Code (OC) for the micro-processor with skip decision/function 113 and code for performing functions associated with the mobile telephone 100.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

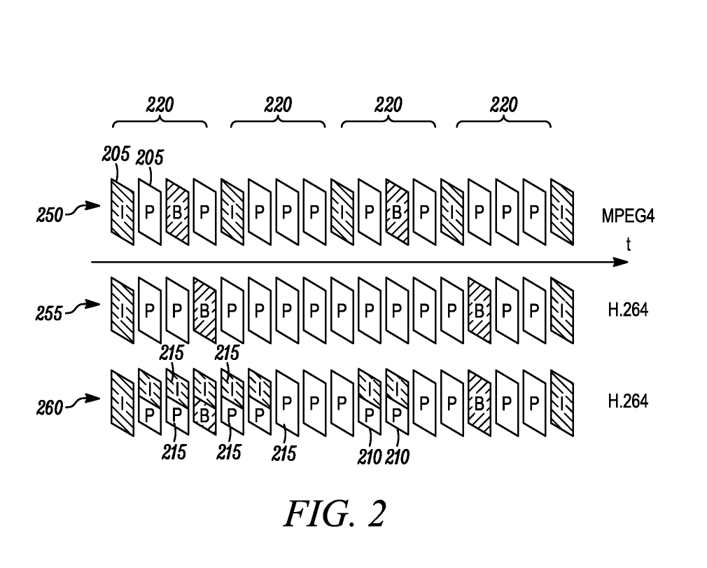

FIG. 2 a schematic diagram illustrating content data blocks according to the MPEG-4 and H.264 standards. An MPEG-4 video stream 250 comprises a sequence of MPEG-4 pictures or compressed content data blocks 205. An MPEG-4 video stream comprises three types of compressed content data block 205—intra-coded frames (I), predictive coded frames (P), and bi-directionally predictive coded frames (B). An intra-coded frame or I-frame is a compressed version of an uncompressed picture. A predictive coded frame or P-frame utilises greater compression than an I-frame as it takes advantage of data in the previous I-frame or P-frame, for example using difference metrics for some pixels instead of all pixel values. B-frames use data from both the previous frame as well as the next or subsequent frame in the sequence. The sequence of MPEG-4 frames 250 comprises a plurality of series 220 of compressed content data blocks 205 each having a non-predictive (I-frame) data block followed by a number of predictive (P-frame and/or B-frame) data blocks as shown schematically. Typically every 15^{th} frame is an I-frame data block, with the data blocks in between being P-frames and/or B-frames. As discussed above, when the delay of the decompressed or decoded frames or pictures becomes too great, some of the predictive (P-frame or B-frame) content data blocks may be dropped or skipped (not decoded) in order to reduce the processing load required to decode the incoming stream or compressed content data block sequence 250.

An H.264 stream comprises a sequence of slices 215 which make up a sequence of frames 255, 260. Each H.264 frame 210 may comprise one or more slices 215 or content data blocks. The slices 215 are decoded separately and so an H.264 frame 210 may require the decoding of more than one slice 215. For example a frame 210 may comprise an intra-coded (I) slice, as well as one or more predictive (P) slices and one or more bi-directional predictive (B) slices as shown. As will be appreciated by those skilled in the art, these predictive (P, B) data blocks or slices may reference up to 16 other slices including slices within the same frame (inter-picture prediction) as well as different frames. One of the sequences 255 of slices or content data blocks 215 comprises one slice per frame. The other sequence 260 comprises frames 210 that include multiple slices 215. In an embodiment, some of the P-slices and/or B-slices may be skipped or not decoded in order to reduce the processing load required to decode the H.264 sequence of frames 255 or 260. This skipping of some slices may be performed in response to the time delay of the decoded frames exceeding a threshold, or in response to other circumstances as described in more detail below.

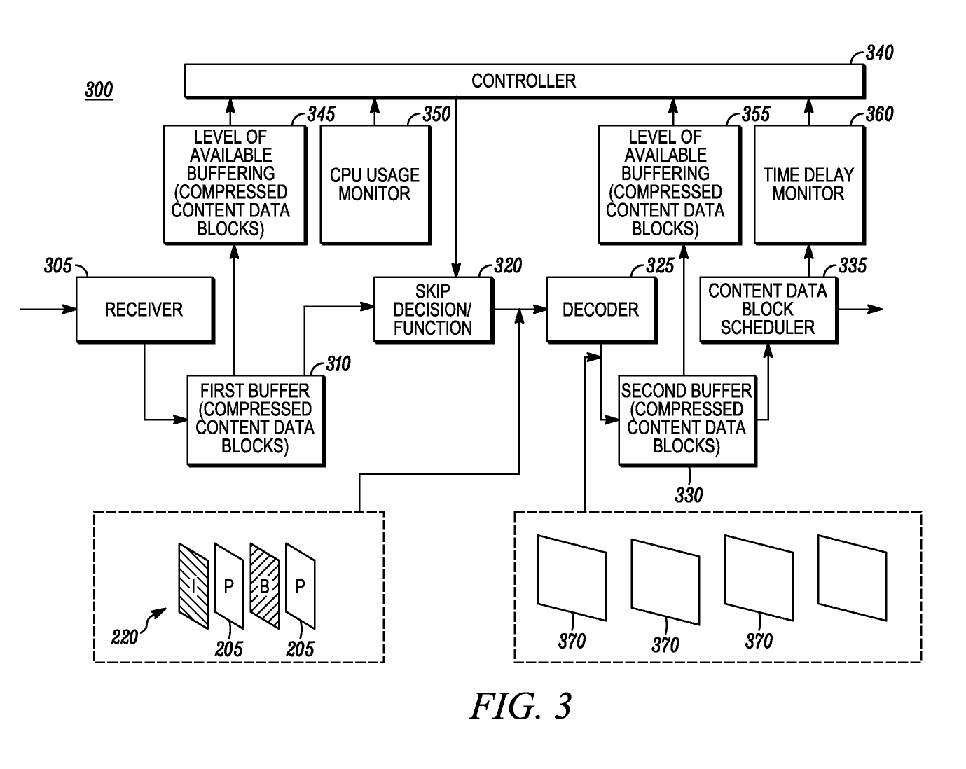

FIG. 3 is a schematic block diagram illustrating functional components implemented on the electronic device of FIG. 1 in accordance with an embodiment of the invention. The figure shows a system for processing received compressed content data blocks. The system 300 may be implemented by the processor 103 including the microprocessor with skip decision/function 113 and the memory 104 of the electronic device 100 of FIG. 1. The system comprises a receiver 305 for receiving compressed content data blocks and which is coupled to a first buffer 310 for buffering the required compressed content data blocks (205, 215) which in turn is coupled to a skip decision/function block 320. The skip decision/function block 320 is coupled to a decoder 325 for decoding the compressed content data blocks into decompressed content data blocks. An output of the decoder is coupled to a second buffer 330 for buffering the decompressed content data blocks. The second buffer 330 is in turn coupled to a content data block scheduler 335. A controller 340 controls the skip decision/function block 320 and receives inputs from an available buffering level for compressed content data blocks function 345, a processor usage monitor 350, an available buffering level for decompressed content data blocks function 355, and a time delay monitor function 360.

The receiver 305 receives compressed content data blocks and may be implemented as a communications protocol stack executed by the processor 103 and coupled to the radio frequency communications unit 102 of the electronics device 100 of FIG. 1 as would be appreciated by those skilled in the art. For example a 3G protocol stack which delivers assembled and correctly sequenced content data blocks using underlying communications protocols. In this embodiment the content data blocks are MPEG-4 or H.264 video data blocks—pictures or slices. The communications protocol stack may operate to implement for example DVB-H, DMB, or ISDB-T. Content data blocks from the receiver 305 are added to the first buffer 310 in order to allow for variations in the rate at which the content data blocks are received by the receiver 305 and decoded by the decoder 325. The first buffer may be implemented using the device RAM 104 for example, or any other suitable buffer mechanism which would be available to those skilled in the art.

The skip decision/function block 320 gets content data blocks from the first buffer 310 and may skip or drop some of them in order to determine a sub-set of compressed content data blocks which are input to the decoder 325. In other words the sub-set of compressed content data blocks to be decoded will omit some of the compressed content data blocks (205, 215) from sequence (250, 255, 260) of compressed content data blocks received form the receiver 305 and buffered in the first buffer 310. Whether and to what extent content data blocks are skipped will depend on a number of performance parameters which together determine a process level of the electronic device 100. The process level provides an indication of the current available processing capacity of the electronics device 100 implementing the system 300, and the impact of this on the ability of the system 300 to decode and play the content data blocks. Generally, the higher the determined process level, the lower the level of processing capacity to decode the content data blocks. Hence a greater number of these content data blocks are skipped or not decoded in order to reduce the processing capacity required by the decoder 325. This enables the system 300 to provide substantially real-time playback of the content stream comprising the compressed content data blocks, and hence to minimise delays and provide a smoother playback experience at the expense of some picture quality.

The decoder 325 decodes or decompresses the compressed content data blocks to generate decompressed content data blocks which are input to the second buffer 330. This is illustrated schematically in FIG. 3 where a series of compressed content data blocks 220 comprising a number of MPEG-4 compressed pictures 205 are decompressed into pictures or decompressed content data blocks 370. Any suitable MPEG-4 or H.264 decoder may be used to generate decompressed MPEG-4 pictures or H.264 slices as appropriate. Similarly any suitable buffering mechanism may be used for the second buffer 330. The decompressed content data blocks are taken from the second buffer 330 by the content data block scheduler 335 which processes the decompressed content data blocks in order to generate images as would be appreciated by those skilled in the art. Any suitable scheduler that would be available to those skilled in the art may be used.

In the embodiment, the controller 340 generates the process level from the performance parameter monitoring processes as follows. The available buffering level for compressed content data blocks function 345 monitors the level of available buffering of the first buffer 310 and may provide the controller 340 with a performance parameter representing the percentage full or percentage capacity available of the first buffer 310 for example. Various buffer monitoring algorithms will be appreciated by those skilled in the art, and any of these could be used in the embodiment. The processor usage monitor 350 monitors the available level of processing capacity of the processor 103 of the electronic device 100, which in addition to implementing the system 300 may be performing other tasks. Typically the processor usage monitor 350 may provide the controller 340 with a performance parameter representing a percentage of the processing capacity currently used or available whilst performing all current tasks executing on the electronic device 100. Various processor usage monitoring algorithms will be appreciated by those skilled in the art, and any of these could be used in the embodiment.

The available buffering level for decompressed content data blocks function 355 monitors the available buffering level or capacity of the second buffer 330 and may provide the controller 340 with a performance parameter representing the percentage full or percentage capacity available of the second buffer 330 for example. Various buffer monitoring algorithms will be appreciated by those skilled in the art, and any of these could be used in the embodiment. The time delay monitor 360 monitors the time stamps of decompressed content data blocks scheduled by the content data block scheduler 355. These time stamps are compared against a current time associated with the electronic device, for example from an on-board clock, in order to determine a time delay. The time delay may be provided to the controller 340 as another performance parameter, however any other suitable performance parameter based on the time delay of the decompressed content data blocks may be used.

The controller 340 uses an algorithm to generate the process level from one or a combination of the performance parameters provided by the available buffering level for compressed content data blocks function 345, the processor usage monitor 350, the available buffering level for decompressed content data blocks function 355, and the time delay monitor function 360. A heavy processing load may result in some of the processing capacity of the processor being diverted away form decoding, resulting in the first buffer filling up. By using the level of available buffering for the compressed content data blocks 345, a heavy decoding load can be detected earlier and skipping can therefore be implemented faster. Thus if the first buffer 310 fills up quickly, skipping of some content data blocks can be implemented quickly. By increasing skipping of content data blocks, the first buffer is emptied more quickly which in turn reduces the delays associated with this buffering. Thus the content data blocks which are not skipped are decoded more quickly resulting in reduced time delays at the scheduler 335, and hence a smoother viewing experience for a user of the system 300.

The system may be used for MPEG-4 and H.264 data blocks. For MPEG-4, pictures or frames are skipped, however for H.264, slices are skipped. The skip decision/function 320 may additionally include a picture/slice decision function which determines whether the sequence of content data blocks are MPEG-4 or H.264 so that the skip decision/function block 320 can skip slices 215 or pictures/frames 205 as appropriate. The determination of whether slices or pictures/frames are received may be made based on the streaming session set-up data as would be appreciated by those skilled in the art.

The amount of skipping or the number of compressed content data blocks not decoded can be determined dynamically based on the process level. For example when a first process level threshold is exceeded, the next predictive content data block (P or B slice or picture) may be skipped. This first process level threshold may correspond to a processor (103) which implements the system 300 performing other tasks (ie processor usage <100% for system), and having a first buffer which is 75% full for example. These performance parameters may be varied when for example the time delay increases or the level of the second buffer increases. Thus the process level may be determined as follows:

Process Level=c1.B1+c2.U+c3.B2+c4.T

Where:
B1=the performance parameter associated with the level of available buffering in the first buffer (345);
U=the performance parameter associated with the processor usage (350);
B2=the performance parameter associated with the level of available buffering in the second buffer (355);
T=the performance parameter associated with the time delay of the decompressed content data blocks (360); and
c1, c2, c3, and c4 are coefficients or weightings for B1, U, B2, and T respectively.

The weightings may be determined experimentally or otherwise designed according to a design requirements as would be appreciated by those skilled in the art, and may depend on factors such as the processor used, the receiving rate of the receiver 305 and so on. In some embodiments, only B1 or B2 may be used. Similarly, as already discussed, the performance parameters B1, U, B2, T may be any suitable parameters based on respectively: the buffer level of the first buffer; processor usage; the buffer level of the second buffer; time delay of scheduled pictures/slices.

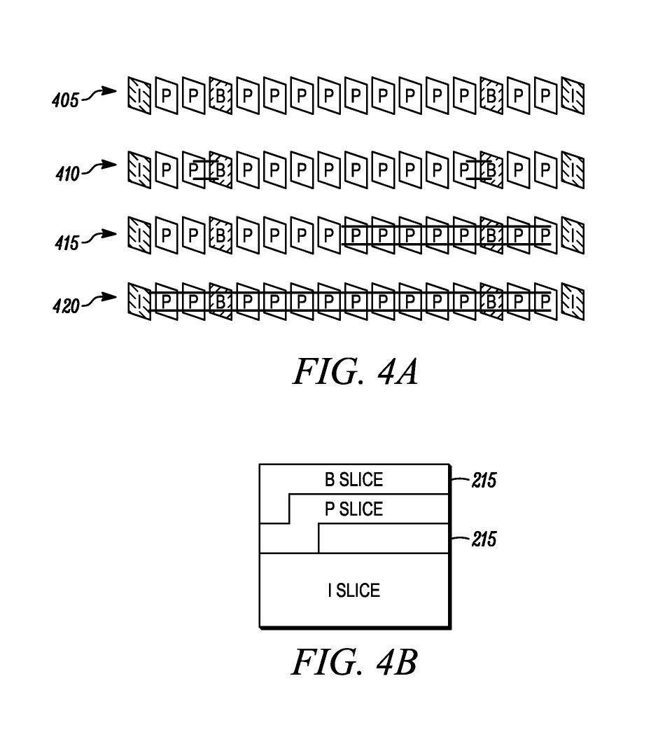

FIG. 4A is a schematic diagram illustrating the skipping of compressed content data blocks in accordance with an embodiment of the invention. Four levels or modes of skipping for MPEG-4 pictures, H.264 slices or more generally compressed content data blocks are shown. Four identical received sequences of MPEG-4 pictures 405, 410, 415, 420 are shown. In the embodiment, three process level thresholds are used, and the amount of skipping is increased as each of those thresholds is exceeded. The thresholds and the skipping response are outline as follows:

First process level threshold exceeded—skip a B or P picture or slice;

Second process level threshold exceeded—skip remaining P and B pictures or slices until next I picture or slice; and

Third process level threshold exceeded—skip all P and B pictures or slices until third threshold not exceeded.

The first sequence 405 corresponds to a process level below the first process level threshold, and hence no skipping is implemented. The second sequence 410 corresponds to a process level above the first process level threshold, and in response a P or B picture is skipped. If the process level remains above the first process level threshold a further P or B picture is skipped, and so on until the process level falls below the first process level threshold. The third sequence 415 corresponds to a process level above the second process level threshold, and in response all P and B pictures are skipped until the next I picture. If the process level remains above the second process level threshold when next determined, then the subsequent P and B pictures are also skipped until the next I picture. This skipping response continues until the process level falls below the second process level threshold. The fourth sequence 420 corresponds to a process level above the third process level threshold, and in response all P and B pictures are skipped until the process level falls below the third process level threshold. By skipping or omitting some of the compressed content data blocks (P, B), a sub-set of compressed content data blocks to be decoded is determined.

FIG. 4B is a schematic diagram illustrating the skipping of compressed H.264 slices in accordance with an embodiment of the invention. An H.264 frame 450 is shown in which one of the slices 215 making up the frame 450 is skipped. A B-slice is skipped so that the frame is decoded with the I-slice, A B-slice and a P-slice thereby reducing the decoding load. Whilst the content data blocks corresponding to the H.264 slices are of a variable size unlike the pictures of MPEG-4, the slices are still in a sequential order and therefore may be skipped in the same manner as the MPEG-4 frames or pictures.

Skipping may be implemented using any mechanism available to those skilled in the art, for example deleting content data blocks from the first buffer, or switching only the content data blocks which are not to be skipped from the first buffer to the decoder. Any other suitable method may be used to determine the sub-set of compressed content data blocks to be decoded in which some of the compressed content data blocks are omitted.

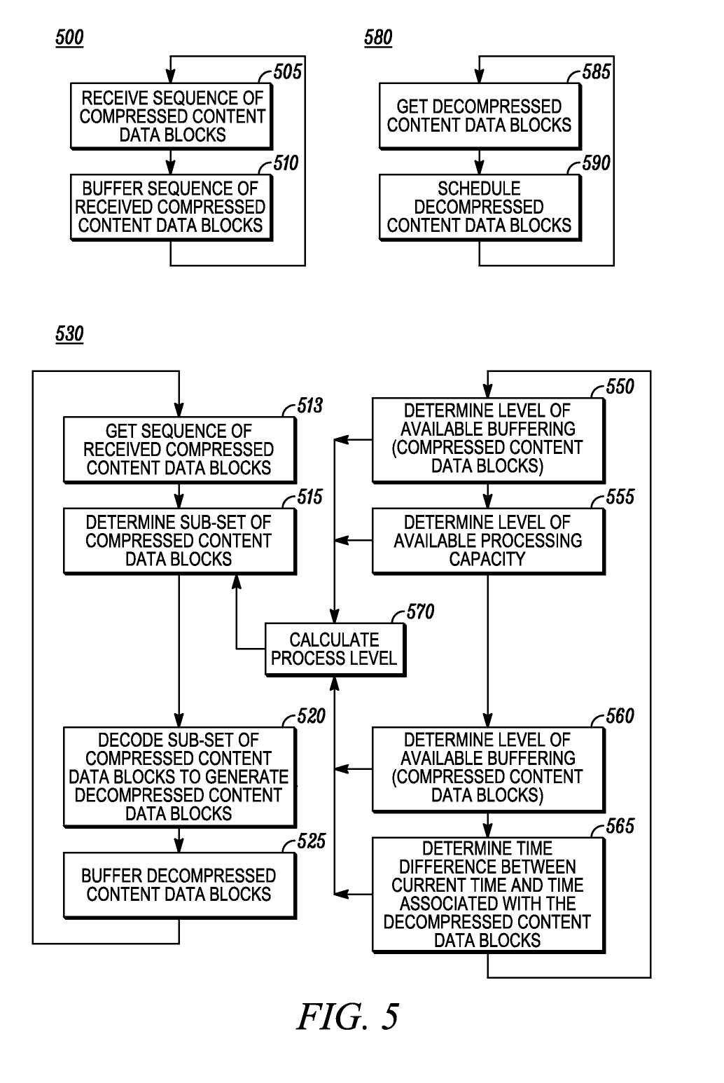

FIG. 5 is a flow diagram illustrating a set of three overlapping methods for skipping content data blocks in accordance with an embodiment of the invention. A method 500 of buffering a sequence of received compressed content data blocks which may be implemented by the receiver 305 and first buffer 310 of the system 300 of FIG. 3 is shown. The method 500 receives a sequence of compressed content data blocks at step 505. This step may be implemented using any suitable hardware and/or software as would be appreciated by those skilled in the art, for example the radio unit (102) of FIG. 1 and communications protocol stack software. The method 500 then buffers the sequence of received compressed content data blocks at step 510. This step may be implemented by the first buffer (310) of the system (300) of FIG. 3.

A method 530 of determining and decoding a sub-set of compressed content data blocks and which may be implemented by the skip decision/function 320, the decoder 325 and the second buffer 330 of the system 300 of FIG. 3 is also shown. The method 530 gets the sequence of received compressed content data blocks at step 513. This step may be implemented by the skip decision/function block 320 receiving compressed content data blocks from the output of the first buffer 310. The method 530 then determines a sub-set of compressed content data blocks at step 515. This step may be implemented by skipping some of the content data blocks from the sequence of received content data blocks. Thus for example under extreme processing load only the I-pictures or I-slices of an MPEG-4 or H.264 sequence may be forwarded to the decoder for decompressing. In this example all of the P and B data blocks are skipped as previously described with respect to FIG. 4 when the third process level threshold is exceeded.

The sub-set of compressed content data blocks is dependent on a number of performance parameters, including the level of available buffering for the compressed content data blocks. This level is determined at step 550 and may be implemented by monitoring the fill level of the first buffer (310) of the system of FIG. 3. More generally, determining the sub-set of the compressed content data blocks, in this embodiment the amount of skipping, is dependent on a process level which in turn is dependent on the level of available buffering for the compressed content data blocks. The process level is also dependent on the level of available processing capacity, which is determined at step 555. This step may be implemented using any suitable processor usage algorithm which is available to the skilled person. The process level is also dependent on the level of available buffering for the decompressed content data blocks. This level is determined at step 560 and may be implemented by monitoring the fill level of the second buffer (330) of the system of FIG. 3. The process level is also dependent on the time delay of the scheduled decompressed content data blocks, and this is determined at step 565. This step may be implemented by monitoring timestamps associated with the scheduled decompressed content data blocks and comparing these with a current time. Each of the performance parameter monitoring processes 550, 555, 560, 565 each generate a performance parameter which is used to calculate a process level at step 570. A suitable algorithm is used as previously described, and different sub-sets of the compressed content data blocks are determined depending on whether the process level exceeds one or more thresholds. An example process for determining the sub-sets of compressed content data blocks is described in more detail below.

Following determination of the sub-set of compressed content data blocks, the method 530 then decodes the sub-set of compressed content data blocks in order to generate decompressed content data blocks at step 520. This step may be implemented in the decoder (325) of the system of FIG. 3. Any suitable decoder can be used, for example MPEG-4 or H.264 as appropriate. The method 530 then buffers the decompressed content data blocks at step 525. This step may be implemented using the second buffer (330) of the system of FIG. 3.

A method 580 of scheduling decompressed content data blocks and which may be implemented by the second buffer 330 and the content data block scheduler 335 of the system 300 of FIG. 3 is shown. The method 580 first gets the decompressed content data blocks at step 585. This step may be implemented by the content data block scheduler 335 receiving compressed content data blocks from the output of the second buffer 330. The method 530 then schedules the decompressed content data blocks at step 590. This step generates user viewable images from the decompressed content data blocks and may be implemented using the content data block scheduler (335) of the system of FIG. 3.

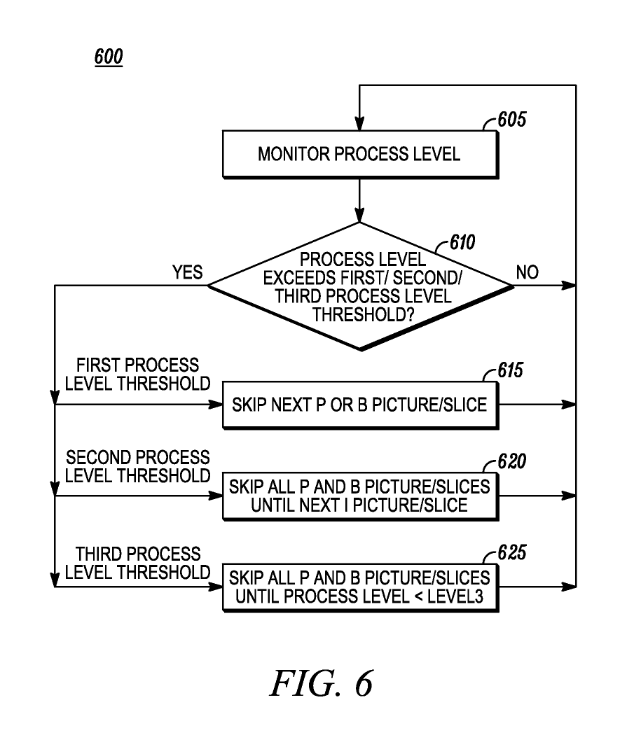

FIG. 6 is a flow diagram illustrating a method of determining a process level for the method of FIG. 5 in accordance with an embodiment of the invention. A method for implementing the step 515 of determining a sub-set of compressed content data blocks is shown. This method 600 may be implemented by the skip decision/function block 320 of the system 300 of FIG. 3. The method 600 first monitors the current process level at step 605. This step may be implemented by the controller (340) which as previously described calculates the process level dependent on the various performance parameters associated with the first and second buffers (345 and 355), the processor usage level (350), and the time delay of the decompressed content data blocks (360). The method 600 then determines whether the current process level exceeds one of the three process level thresholds previously described at step 610. If this is not the case (Level 0), then the method returns to monitor the (new) current process level at step 605.

If however the process level exceeds the first process level threshold (Level 1), then the method skips the next non-predictive content data block at step 615. This step may be implemented by skipping a P-picture or B-picture in a MPEG-4 sequence, or a P-slice or a B-slice in an H.264 sequence of received content data blocks. In alternative embodiments two or another predetermined number of compressed content data blocks may be skipped. Following this skipping step 615, the method returns to the monitor process level step 605. The effect of skipping a content data block may have been to reduce the level of available buffering, the CPU usage or other performance parameters which may have lowered the process level below the first threshold, in which case no further skipping is implemented. However if this is not the case, further skipping of a compressed content data block may be implemented. Note also that a reduced process level may result from the processor (102) finishing an unrelated task so that it is now fully occupied with processing the content data.

If the process level exceeds the second process level threshold (Level 2), then the method skips all the predictive (P and B) content data blocks until the next non-predictive (I) content data block at step 620. The method then returns to monitor the process level at step 605. Generally this step 620 will result in a plurality of the B and P slices or pictures being skipped between I slices or pictures. Following the skipping of predictive data blocks (P and B) within a series of compressed content data blocks, the next series will be retrieved from the first buffer beginning with the non-predictive (I) data block. The method then again checks whether the process level has fallen, and if it remains elevated and exceeding the second threshold (Level 2), again the remaining predictive (P and B) data blocks are skipped. This may result in the last half or even three quarters of the predictive data blocks of each series being skipped.

If the process level exceeds the third process level threshold (Level 3), then the method skips all the predictive (P and B) content data blocks at step 625. The method only returns to monitor the process level at step 605 when the process level has fallen below the third process threshold.

Thus each time the process level exceeds one of the process level thresholds, a sub-set of the compressed content data blocks is determined using corresponding skipping. In alternative embodiments other methods of determining sub-sets of the compressed content data blocks may be used. Similarly, a different number of threshold may be used, and the skipping function applied to each may be modified as would be appreciated by those skilled in the art.

As noted previously, the embodiment enables smooth playback of the content stream by skipping some of the content data blocks depending on various performance parameters related to the processor loading of the electronic device. This processor loading may be caused for example by the processor capacity being used by other tasks not related to processing the content stream. An increase in processor loading can be manifested in various ways including delays to the decoded content data blocks, and reduced availability of buffering for both compressed and decompressed content data blocks. By using the available buffering levels to determine the processor loading and/or the implied delays to processing the content stream, the electronic devices response to this situation can be improved.

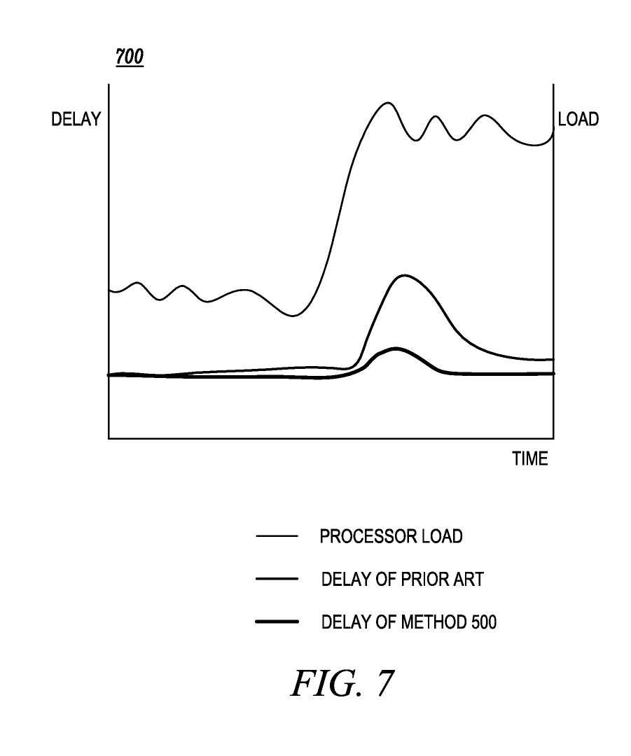

FIG. 7 is a graph illustrating the expected delay in processing decompressed video data blocks in order to display the corresponding video pictures when using the method of FIG. 5 and a known method. The graph shows the processor load over time and its effect on the delay of pictures displayed in response to processing content data blocks. One of the delay plots corresponds to the method of FIG. 5 and the other corresponds to a known method in which the skipping of compressed content data blocks is controlled in response to delays in the decompressed content data blocks. It can be seen that as the processor load increases, the delay of the displayed pictures increases. This delay then reduces as some of the compressed video (content) data blocks are skipped. However the increase in delay and the speed of the subsequent reduction in delay is markedly reduced with the method of FIG. 5.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

The skilled person will recognise that the above-described device and methods may be embodied as processor control code, for example on a carrier medium such as a disk, CD- or DVD-ROM, programmed memory such as read only memory (Firmware), or on a data carrier such as an optical or electrical signal carrier. For some applications embodiments of the invention may be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable device such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

We claim:

1. A method for processing content data, comprising:
buffering a sequence of received compressed content data blocks;
determining a level of available buffering for the received compressed content data blocks;
determining a sub-set of compressed content data blocks to be decoded from the sequence of received compressed content data blocks, the sub-set of compressed content data blocks being dependent on the level of available buffering; and
decoding the sub-set of compressed content data blocks to generate decompressed content data blocks.

2. A method as claimed in claim 1, further comprising buffering the decompressed content data blocks, and wherein the sub-set of compressed content data blocks is also dependent on the level of available buffering for the decompressed content data blocks.

3. A method as claimed in claim 1, wherein the sub-set of compressed content data blocks is also dependent on the level of available processing capacity of an electronic device performing the method.

4. A method as claimed in claim 1, wherein the sub-set of compressed content data blocks is also dependent on a time difference between a current time and a time associated with the decompressed content data blocks.

5. A method as claimed in claim 1, wherein the sub-set of compressed content data blocks is dependent on a process level, the process level being dependent on the level of available buffering and one of the following group: the level of available buffering for the decompressed content data blocks; the level of available processing capacity of an electronic device performing the method; a time difference between a current time and a time associated with the decompressed content data blocks.

6. A method as claimed in claim 5, wherein the sequence of received compressed content data blocks comprises a plurality of series of compressed content data blocks each having a non-predictive (I) content data block followed by a number of predictive (P or B) content data blocks, the predictive (P or B) content data blocks of each series of compressed content data blocks being dependent on the respective non-predictive (I) content data block; and wherein at least some of the predictive (P or B) content data blocks from each series of compressed content data blocks are omitted from the sub-set of compressed content data blocks to be decoded in response to the process level exceeding a first process level threshold.

7. A method as claimed in claim 6, wherein the remaining predictive (P or B) content data blocks in a said series of compressed content data blocks are omitted in response to the process level exceeding a second process level threshold which is higher than the first process level threshold.

8. A method as claimed in claim 7, wherein the predictive (P or B) content data blocks in the sequence of received compressed content data blocks are omitted in response to the process level exceeding a third process level threshold which is higher than the second process level threshold.

9. A method as claimed in claim 1, wherein the content data blocks are MPEG-4 video frames or H.264 video slices.

10. A method as claimed in claim 1, wherein determining a sub-set of compressed content data blocks to be decoded from the sequence of received compressed content data blocks comprises not decoding some of the sequence of received compressed content data blocks following said buffering.

11. An electronic device comprising:
a buffer arranged to buffer a sequence of received compressed content data blocks;
a decoder coupled to the buffer and arranged to generate decompressed content data blocks in response to receiving compressed content data blocks;
a processor arranged to determine a level of available buffering for the compressed content data blocks from the buffer and to determine a sub-set of compressed content data blocks to be forwarded to the decoder from the buffer, the sub-set of compressed content data blocks being dependent on the level of available buffering.

12. An electronic device as claimed in claim 11, further comprising a second buffer coupled to an output of the decoder and arranged to buffer decompressed content data blocks, and wherein the sub-set of compressed content data blocks is also dependent on a level of available buffering for the decompressed content data blocks of the second buffer.

13. An electronic device as claimed in claim 11, wherein the sub-set of compressed content data blocks is also dependent on the level of available processing capacity of the electronic device.

14. An electronic device as claimed in claim 11, wherein the sub-set of compressed content data blocks is also dependent on a time difference between a current time used by the processor and a time associated with a said decompressed content data block.

15. An electronic device as claimed in claim 11, wherein the sub-set of compressed content data blocks is dependent on a process level, the process level being dependent on the level of available buffering and one of the following group: the level of available buffering for the decompressed content data blocks; the level of available processing capacity of an electronic device performing the method; a time difference between a current time and a time associated with the decompressed content data blocks.

16. An electronic device as claimed in claim 15, wherein the sequence of received compressed content data blocks comprises a plurality of series of compressed content data blocks each having a non-predictive (I) content data block followed by a number of predictive (P or B) content data blocks, the predictive (P or B) content data blocks of each series of compressed content data blocks being dependent on the respective non-predictive (I) content data block; and wherein the processor is arranged to omit at least some of the predictive (P or B) content data blocks from each series of compressed content data blocks from the sub-set of compressed content data blocks to be decoded in response to the process level exceeding a first process level threshold.

17. An electronic device as claimed in claim 16, wherein the processor is arranged to omit the remaining predictive (P or B) content data blocks in a said series of compressed content data blocks in response to the process level exceeding a second process level threshold which is higher than the first process level threshold.

18. An electronic device as claimed in claim 17, wherein the processor is arranged to omit the predictive (P or B) content data blocks in the sequence of received compressed content data blocks in response to the process level exceeding a third process level threshold which is higher than the second process level threshold.

19. An electronic device as claimed in claim 11, wherein the content data blocks are MPEG-4 video frames or H.264 video slices.

20. An electronic device as claimed in claim 11, wherein the processor is arranged to skip some of the sequence of compressed content data blocks from the buffer in order to determine the sub-set of compressed content data blocks to be decoded.
